(19) United States
(12) Patent Application Publication
(10) Pub. No.: US 2013/0013330 A1
(43) Pub. Date: Jan. 10, 2013

(54) METHOD FOR ASSESSMENT OF AESTHETIC AND MORPHOLOGICAL CONDITIONS OF THE SKIN AND PRESCRIPTION OF COSMETIC AND/OR DERMATOLOGICAL TREATMENT

(75) Inventors: Elaine Cristine Guerra, Sao Paulo (BR); Luciana De Miranda Chaves Vasquez Pinto, Itapecerica da Serra (BR); Elaine Cristina De Oliveira, Sao Paulo (BR)

(73) Assignee: NATURA COSMETICOS S.A., Itapecerica da Serra (BR)

(21) Appl. No.: 13/520,113

(22) PCT Filed: Dec. 29, 2010
(86) PCT No.: PCT/BR2010/000434

§ 371 Date: Sep. 25, 2012

(30) Foreign Application Priority Data
Dec. 30, 2009 (FR) 0959665

(51) Int. Cl. G06Q 50/22

(52) U.S. Cl. 705/2

(57) ABSTRACT

It is described a method for assessment of aesthetic and morphological conditions of the skin and prescription of cosmetic and/or dermatological treatment comprising the following steps: A) obtaining information on the age and life habits of a user; B) performing a biometric analysis of a corporeal portion of the user; C) processing the results from the analyses of steps A and B and comparing them with predetermined data on aesthetic and morphological factors of the skin; D) obtaining a skin model of the user according to the data processed in step C; E) linking the user's skin model to predetermined data contained in a database about cosmetic and/or dermatological products; and F) prescribing a treatment and pre-selected cosmetic and/or dermatological products.

The present invention refers to a method for assessment of aesthetic and morphological conditions of the skin and prescription of cosmetic and/or dermatological treatment particularly used to assess the type of skin of a user and to prescribe cosmetic and/or dermatological treatment with specific products for the diagnosed skin.

### BACKGROUND OF THE INVENTION

As it is known by experts in the area, cosmetic advice is currently a service commonly rendered at aesthetic clinics, gyms, beauty saloons, the internet, among other places.

Usually this advice service starts from visual analyses—with the naked eye—or electronic procedures/specialized equipment. After this analysis, a skin model of the user is delineated and then, the expert analyst proceeds with the advice and treatment. The use of this service of cosmetic advice can further occur based on the attribution of a questionnaire containing random questions about the user's skin and habits.

In this regard, a process for diagnosing external corporeal portions and for prescribing an adequate treatment is described in document EP 1210908. The process is based on the obtainment of a digitalized image of the individual's skin, the analysis of the portion captured in image and the prescription of personal care products based on the result of this diagnosis. The characteristics to be assessed include wrinkles, pores, dark circles, among others. The digitalized image is transmitted by computer together with a questionnaire whose answers will be related to the result from determining the skin characteristics of the person. However, this prior art document does not correlate the methodology of image analysis to the preparation of a questionnaire for assessing the user's life conditions capable of estimating unfavorable conditions expressed on the skin.

Document US 2004/0143513 describes a method to provide a program of customized treatment for each consumer based on the obtainment of information on the target consumer by means of a questionnaire. Based on the information, a program for specific and individualized treatment is created. However, the method described in this prior art document does not cover a methodology of biometric analysis that complements the application of a questionnaire to the user of the method of customized treatment.

U.S. Pat. No. 7,437,344, though, refers to a method to provide advice on beauty, comprising the reception of specific information on the user, access to a structure of information listing categories of specific information on the user and advice on beauty. This method uses artificial intelligence (fuzzy logic) to compare the information obtained from the user with predetermined information. The specific information on the user consists of skin type, skin color, hair type, favorite cosmetics, allergies, climate, lifestyle, among others. However, one observes that it is not specifically defined or described the use of any equipment for self-diagnosing the aging level or damages to the skin during the steps of the method.

Moreover, the state of the art reveals devices targeted to the self-assessment of a user's skin, such as U.S. Pat. No. 6,571,003, which covers a method and equipment for locating one or more visual flaws in portions of a person's skin. This method comprises the acquisition of the digital image of a portion of the person's skin, the electronic analysis of this captured image, the location of the area containing the flaw and the generation of a comparison between the data obtained with predetermined data. However, it is not described the specific use of this method and equipment for advice on dermatological or cosmetic products, because the main goal of this device is to identify flaws in the skin, and such advice would be the operator's responsibility.

As it can be observed above, there are no documents already disclosed by the state of the art which refer to a method for assessment of aesthetic and morphological conditions of the skin and prescription of cosmetic and/or dermatological treatment. In other words, it has not been developed yet a method for aesthetic advice based on the analysis of the skin concomitantly with a behavioral analysis of the user in order to consequently formulate a skin model of said user and further provide customized cosmetic and/or dermatological advice.

### PURPOSES OF THE INVENTION

The present invention aims at providing a method for assessment of aesthetic and morphological conditions of the skin, which provides the prescription of products and cosmetic and/or dermatological treatment which are suitable for the type of diagnosed skin.

### SUMMARY OF THE INVENTION

The invention's subject matter is a method for assessment of aesthetic and morphological conditions of the skin and prescription of cosmetic and/or dermatological treatment comprising the following steps:

A) obtaining information on the age and life habits of a user;

B) performing a biometric analysis of a corporeal portion of the user;

C) processing the results from the analyses of steps A and B and comparing them with predetermined data on aesthetic and morphological factors of the skin;

D) obtaining a skin model of the user according to the data processed in step C;

E) linking the user's skin model to at least two-dimensional predetermined data contained in a database about cosmetic and/or dermatological products; and

F) prescribing a kit of pre-selected cosmetic and/or dermatological products.

### BRIEF DESCRIPTION OF THE DRAWINGS

This invention will be described next, in further details, based on an example of performance represented in the drawing. The figure illustrates:

FIG. 1—illustrates a flowchart with the steps of the method for assessment of aesthetic and morphological conditions of the skin and prescription of cosmetic and/or dermatological treatment covered by this invention.

### DETAILED DESCRIPTION OF THE FIGURES

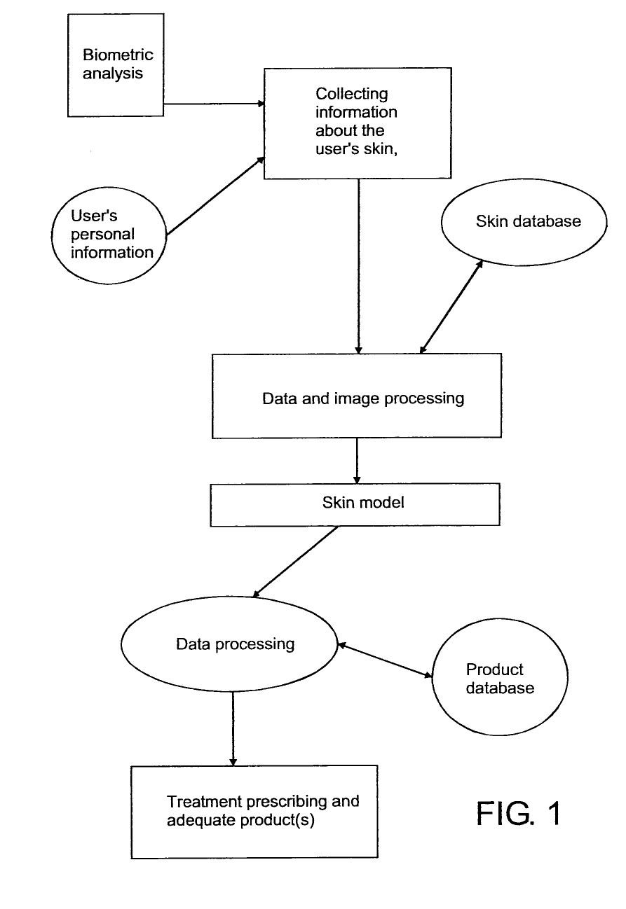

According to a preferred embodiment and as it can be seen in FIG. 1, the method for assessment of aesthetic and morphological conditions of the skin, indication of kit of products and prescription of cosmetic and/or dermatological treatment covered by the present invention comprises, among others, the following steps:

A) sending a questionnaire about the age and life habits of a user;

B) obtaining requested information;

C) processing results from the analysis of step B;

D) comparing them with at least two dimensions of predetermined data about aesthetic and morphological factors of the skin;

E) crossing the result from step D with a database containing information on cosmetic and/or dermatological products; and

F) sending suggestion of kit with product recommended to the user, as well as prescribing cosmetic and/or dermatological treatment related to the kit.

In a preferred embodiment, the method for assessment of aesthetic and morphological conditions of the skin, indication of kit with products and prescription of cosmetic and/or dermatological treatment covered by this invention comprises, among others, the following steps:

A) obtaining information on the age and life habits of a user;

B) performing a biometric analysis of a corporeal portion of the user;

C) processing the results from the analyses of steps A and B and comparing them with predetermined data on aesthetic and morphological factors of the skin;

D) obtaining a skin model of the user according to the data processed in step C;

E) linking the user's skin model to predetermined data contained in a database about cosmetic and/or dermatological products; and

F) prescribing a treatment and pre-selected cosmetic and/or dermatological products.

The method covered by this invention makes use of personal information on the user and data obtained in a biometric analysis of the skin of this user in order to, after specific procedures, allow for prescribing treatment(s) and product(s) which are suitable for the skin of said user, either to repair his/her skin, nourish it, fortify it or simply to keep it healthy.

This method starts with steps A and B which consist of investigating the user's life habits and his/her age. This data can be obtained by means of an electronic questionnaire, for instance, via internet or SMS, or even on paper.

Preferably, this questionnaire contains questions about age, motherhood, addictions (such as smoking), skin type (dry, oily, mixed), occurrence of allergies and the determination of the allergy type, if any, use of sunscreen and frequency thereof, use of some dermatological product, among other questions. Any question about some life habit or personal information on the user that influences the state of his/her skin can be added to this questionnaire.

Optionally, after obtaining personal information on the user, the method follows on to a step B when a biometric analysis of the user's skin is performed. This biometric analysis may consist of corneometry, tomography, cutometry, chromometry or digital photo analysis. This optional step is recommended for detailing and confirming the information given by the user which may be subjective.

Preferably, the biometric analysis is performed through computed tomography, computerized axial tomography, optical coherence tomography or also digital photo analysis.

Personal information on the user and the biometric analysis of his/her skin consists of the input data of the method covered by this invention.

The data of steps A and B or even the data combined with the data of this optional step is sent to a data processor and, optionally, to an image processor, where the concatenated data is converted into search algorithms and compared with predetermined data of at least two dimensions preferably related to aesthetic and morphological factors of the skin contained in a skin database. The image and data processor used in this step C can be remotely positioned in relation with the place for obtaining the data on the user's skin or “in-loco”.

After processing the data and image as search algorithms and including these algorithms in the database about general aesthetic and morphological factors of the skin, a skin model of the user is generated.

The general aesthetic and morphological factors of the skin contained in the database are: age group, level of hydration of the dermis and corneous stratum, skin color, skin shine, sebum level, skin flaccidity/firmness, presence of fine lines, relief and coloration uniformity. Those factors were selected as they provide a solid database to have a general idea of the aging level or damages to the skin during the skin aging process. Preferably, these factors shall be subjected to a biometric methodology selected on a case-by-case basis.

This skin model is generated according to the intensity level of the assessed factors, said intensity level ranging from 1 to 3.

The data obtained for determining the skin model of the user is sent to a new processor, now a data processor, where it is converted into search algorithm and included in a product database. This product database comprises specific information on cosmetic and/or dermatological products with predetermined correlations defining the reason: product(s) for cosmetic/dermatological treatment x skin type and current state of the skin (skin model).

Preferably, the compositions of the cosmetic and/or dermatological products contained in the product database essentially comprise an active ingredient and a physiologically adequate vehicle. The active ingredients and usual adjuvant cosmetics that are present in the compositions in question can be of animal, vegetal, mineral or synthetic origin.

The products are developed by taking into account the variations of each dimension present in the database.

Thus the data will be used for identifying the products in each dimension.

For instance, the data of the user's age will be used to identify the products recommended for the age group encompassing such age. Thus, there is a first filter.

A second filter can be the skin color. The user indicates the color and this data will be taken into account to filter the products recommended for this type of skin of the user.

The results from the filters are crossed and, as an intersection, the products recommended for the age group and skin color of the user are prescribed.

The user can stop the process by using these two dimensions or, alternatively, he/she can keep providing data and reducing the scope of product options. This case is recommended, for instance, if the range of products resulting from the intersection of the two dimensions is very wide, making the user wonder which product will be best for his/her case.

Thus, the process can continue with the use of a third dimension, such as the skin type.

The user informs the type of his/her skin, and such information will be considered in the result from the intersection of the last two filters. The answer from crossing the data of the last two filters with this third filter will be then the indication of a kit with products to the user, as well as how to use products targeted to his/her age, skin color and skin type.

The process may continue until the result from the research becomes repetitive or until the dimensions with data in the base finish.

This process excludes opinions of physicians and the prescription of products by them.

Among the options of active ingredients that can be present in these compositions, the following can be highlighted: active agents that induce the production of collagen fibers and elastins; anti-inflammatory agents; chemical and physical sunscreens; exfoliating agents; moisturizing agents and emollients; agents that stimulate the proliferation and differentiation of fibroblasts; among others.

As regards the physiologically acceptable vehicle, it consists of a usual cosmetic or dermatological foundation according to the application intended for the composition to be prepared. This vehicle has physiologically inert compounds and usual adjuvant agents.

Some examples of adjuvant agents will be listed next—in a non restrictive manner, but only in a demonstrative manner.
Water: Water is the base of several preferred embodiments of cosmetic and dermatological compositions in general. Water acts as a vehicle for the other components. The formulations of the compositions of the cosmetic and/or dermatological products, mentioned during the steps of the method covered by this invention, comprise preferably demineralized or distilled water at a suitable percentage (q.s.p.) to achieve 100% of the formula based on the total weight of the composition. Obviously, other cosmetically acceptable vehicles can be used in the present invention.
Antioxidant agents: BHT, tocopherol and/or the derivatives thereof, catechins, tannins and/or the derivatives thereof, phenolic compounds, hydroquinone, among others;
Preservative agents: mehylparabens, propylparabens, isothiazolinones, phenoxyethanol;
Film forming agents: agar gum, carrageenan gum, alginates, gum Arabic, gelatin;
Agents that form microcrystalline net for support: dextrans, methyl-acrylates, PHB, PHA;
Polymeric agents and/or copolymer agents: silicone copolymers, siloxane polymers and/or modified silicone polymers, acrylate copolymers;
Denaturant agents: denatonium benzoate;
Consistency agents: vegetable waxes, mineral hydrocarbons, paraffin, bee wax, white wax, whale spermaceti, cocoa butter, shea butter, sugarcane wax;
Emollients: liquid paraffin, palm oil, cupuagu butter, lecithin, milk amino acids, wheat protein, vegetable proteins, phospholipid vegetable oils, ceramides, passion fruit ceramide, sphingolipids, whale spermaceti, lanoline, almond oil, dicapryl carbonate, silicone elastomers, cyclomethicone;
Humectants and/or moisturizing agents: glycerin, propylene glycol, hyaluronic acid, urea, PCA; and
Conditioner agents: quaternary ammonium salts, silicones, siloxanes.

The main examples of galenical forms of cosmetic and/or dermatological products comprising the database mentioned in step E) of the method covered by this invention are:

a) Fluid or semisolid emulsion, for instance:
Body milk moisturizer;
Face milk moisturizer;
Body lotion moisturizer;
Face lotion moisturizer;
Sunblocks or sunscreens for adults or children, intended or not for the concomitant use with the practice of sports;
Facial or body moisturizers;
Facial or body anti-aging products;
Body or facial firming products;
Self-tanning products;
Insect repellent products;
Body or facial skin brightening moisturizers;
Anti-cellulite products;
Products for sensitive skin.

b) Gels, for instance:
Products for the scalp;
Pharmaceutical preparations for topical use;
Body or facial cosmetic preparations for children;
Anti-acne products;
Anti-cellulite products;
Products for sensitive skin;

c) Suspensions, for instance:
Ointments;
Cosmetic preparations for localized action, specific for the periocular region, lips contour, lips, anti-blemish products, anti-dark circles products, among others;
Liniments;

d) Other examples:
Lipsticks and waxen foundations;
Pigmented foundations;

In order to exemplify possible formulations concerning preferred embodiments of the present invention, displayed below are formulations of cosmetic and/or dermatological products that can comprise the database mentioned in step E) of the method covered by this invention:

The data processor can be remote or “in-loco” and has the function of setting up, based on the algorithms of search for cosmetic and/or dermatological products and on the data of the product database, an aesthetic customized treatment comprised by cosmetic and/or dermatological products targeted for the skin model of the user.

This way, the main advantage of the method covered by this invention is the function of prescribing treatment(s) and product(s) that are customized and suitable for the skin model of the user based on collected information about the user's skin, in an accurate and broadening manner, taking into account not only the biometric analysis, but also the user's personal information.

By the end of the method covered by this invention, the user obtains customized aesthetic advice which is, therefore, more appropriate, safer, more practical and efficient than the cosmetic and dermatological pieces of advice already known.

1-14. (canceled)

15. A computer-implemented method for assessment of aesthetic and morphological conditions of the skin and prescription of cosmetic and/or dermatological treatment, said method comprising the steps of:
A) obtaining information on the age and life habits of a user by means of a questionnaire;
B) performing a biometric analysis of a corporeal portion of the user, the analysis comprising corneometry, tomography, cutometry, chromometry or digital photo analysis;
C) receiving and storing data in one or more memory storage areas, the data comprising the results from the analyses of steps A and B;
D) processing, via at least one computer processor, the data received in step C and comparing the data with predetermined data contained in a first database on aesthetic and morphological factors of the skin;
E) generating, via the at least one computer processor, a skin model of the user according to the data processed in step D;
F) linking the user's skin model to predetermined data contained in a second database about cosmetic and/or dermatological products; and
G) prescribing a treatment and pre-selected cosmetic and/or dermatological products.

16. Method according to claim 15, wherein, in step B, the biometric analysis further being is performed through computed tomography, computerized axial tomography or optical coherence tomography or digital photo analysis.

17. Method according to claim 15, wherein, after step B and before step D, the data generated in steps A and B are concatenated.

18. Method according to claim 15, wherein the at least one computer processor of steps D and E comprises a data and image processor.

19. Method according to claim 18, wherein the data and image processor is remotely located relative to a location for performing at least steps A and B.

20. Method according to claim 18, wherein, in step D, the data and image processor receives the concatenated data, converts the concatenated data into algorithms of search for aesthetic factors.

21. Method according to claim 20, wherein the algorithms of search for aesthetic factors are included in a database about general aesthetic and morphological factors of the skin, generating the skin model of the user.

22. Method according to claim 21, wherein the general aesthetic and morphological factors of the skin are: level of hydration of the dermis and corneous stratum, skin shine, sebum level, skin flaccidity/firmness, relief and coloration uniformity.

23. Method according to claim 22, wherein the skin model of the user is generated according to the intensity level of the assessed factors, said intensity level ranging from 1 to 3.

24. Method according to claim 15, wherein step F occurs via a second processor, the second processor being a data processor.

25. Method according to claim 15, wherein step F occurs via a second processor, the second processor being a data processor remotely located relative to a location for performing at least steps A and B.

26. Method according to claims 24, wherein, in step F, the data processor receives the data of the skin model of the user, converts the data of the skin model of the user into algorithms of search for cosmetic and/or dermatological products.
